(19) United States
(12) Patent Application Publication
(10) Pub. No.: US 2005/0241711 A1
(43) Pub. Date: Nov. 3, 2005

(54) Removable closure system and plug for conduit

(76) Inventors: Jared Sayers, Red Deer (CA); Amanjeet Dhaliwal, Red Deer (CA); David Ebl, Condor (CA); Doug Hayes, Red Deer (CA); Alain Loyer, Calgary (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 11/022,877

(22) Filed: Dec. 28, 2004

Related U.S. Application Data
(60) Provisional application No. 60/566,098, filed on Apr. 29, 2004.

(51) Int. Cl. F16L 55/10

(52) U.S. Cl. 138/89; 138/90; 138/97

(57) ABSTRACT

The invention provides a removable closure system comprising a tubular member having an internal surface with an internal profile therein, an entrance end and a plug end, the internal profile providing a collet shoulder and a plug stopping shoulder. A plug assembly is positioned within the tubular member. The plug assembly has a plug suitable for insertion through the tubular member at the entrance end and past the collet shoulder, a collet with a plurality of collet fingers. The collet fingers are moveable between a collapsed and a normally expanded condition, the collapsed condition suitable for insertion of the plug assembly through the tubular member past the collet shoulder and the expanded condition suitable for engaging the collet shoulder. When the plug assembly is placed in the tubular member against the plug stopping shoulder, and the collet fingers are in the expanded condition engaging the collet shoulder, the plug assembly is removably secured in the tubular member.

### CROSS REFERENCE TO RELATED APPLICATION

This application is a regular application of U.S. Provisional Patent Application Ser. No. 60/566,098 filed Apr. 29, 2004 and entitled, “NOVEL HOT TAPPING METHOD, SYSTEM AND APPARATUS”, the entirety of which is incorporated herein by reference.

### FIELD OF THE INVENTION

The present invention relates generally to a system for removably placing a device inside a conduit, and more particular to a system for removably placing a plug, either solid or flow-through, in a branch pipeline or other tubular member which was hot tapped onto a main pipeline.

### BACKGROUND OF THE INVENTION

In pipeline hot tapping operations it is frequently necessary to close, or to block access to, the interior of a tubular member either permanently or semi-permanently. Pipeline hot taps are used when repairing a defective area of a line without taking it out of service, by setting up a bypass line to provide a path for fluid flow while the defect is repaired. Hot taps may also be used to install a new branch line; again without taking the main pipeline out of service.

After the hot tap operations are completed, tubular members, such as flanges or nipples which are welded onto the main line during the hot tap, may need to be closed or partially blocked. For example, after repairs are complete the openings that provide communication between the main line and bypass line will need to be closed. Preferably the closure is made in such a way that at some future date access can again be obtained through the same opening. Alternatively, in the case of the addition of a branch line, it is often desirable to place a device in the opening which causes pipeline pigs to traverse it, but which still allows for adequate flow of fluid to continue to pass. Without such a blocking device pipeline pigs could lodge themselves in the opening between the main pipeline and branch line.

One conventional means for locking a device in place inside a flange is the Lock-O-Ring™ system from T. D. Williamson, Inc. of Tulsa, Okla. and as disclosed in T. D. Williamson, Inc.'s Bulletin No. 1120.001.01. The Lock-O-Ring™ system utilizes a flange, a retainer ring mounted on the inner cylindrical bore therein, a plug having an annular groove for insertion into the flange and for receiving a portion of the retainer ring, and retainer screws carried in radial passages in the flange for advancing the retainer ring partially into the plug's annular groove thereby locking the plug in place. The T. D. Williamson Bulletin also discloses a plug with guide bars to permit pigs to traverse the opening while allowing for an adequate flow of fluid to continue to pass.

However, the Lock-O-Ring™ system suffers from a number of disadvantages. One primary disadvantage is that it requires the precise coaxial alignment of the plug's annular groove with the retainer ring in the flange, all while rotating the retainer screws to advance the ring. A related problem is that if a worker rotates the screws before the plug is in place, it is possible for the retainer ring's segments to fall into the main pipeline. Furthermore, the Lock-O-Ring™ system provides little, if anything, in the way of feedback to the operator to indicate that it is securely locked in place. Finally, the Lock-O-Ring™ system does not enable axial adjustment of the guide bars, relative to the plug, so as to precisely align the bars with the opening into the main pipeline.

Another system for locking a device in place, inside a flange, is disclosed in U.S. Pat. No. 6,286,553 to Morgan. Morgan teaches a plug which utilizes a radially outward movable snap ring, which engages an annular groove inside a flange, to retain the plug in position. Morgan also discloses an internal circumferential ledge, inside the flange, to assist with the coaxial alignment of the snap ring with the annular groove. Although this solves some of the problems of the prior art, the system is complex, involving moving mechanical parts, it provides little, if any, feedback to indicate that it is securely locked in place, and it does not provide a plug with guide bars to allow flow through while allowing pigs to transverse the opening.

What is needed is a system to removably place a closure or flow-through plug inside a conduit which is simple, provides feedback to the operator that it is locked in place and which provides for axial adjustment of guide bars relative to the plug.

### SUMMARY OF THE INVENTION

The invention provides a removable closure system comprising a tubular member having an internal surface with an internal profile therein, an entrance end and a plug end, the internal profile providing a collet shoulder and a plug stopping shoulder. In a typical application of the invention the tubular member may be in the form of a flange member, that is, a tubular member that has an integral radially extending flange portion that is readily adaptable for the attachment of other structural or piping devices. In another application of the invention the tubular member may be in the form of a nipple. In a preferred embodiment, the tubular member will be mounted to a pipeline or other conduit.

A plug assembly is positioned within the tubular member. The plug assembly has a plug, suitable for insertion through the tubular member at the entrance end and past the collet shoulder, and a collet with a plurality of collet fingers. The collet fingers are moveable between a collapsed and a normally expanded condition, the collapsed condition suitable for insertion of the plug assembly through the tubular member past the collet shoulder and the expanded condition suitable for engaging the collet shoulder.

When the plug assembly is placed in the tubular member against the plug stopping shoulder, and the collet fingers are in the expanded condition engaging the collet shoulder, the plug assembly is removably secured in the tubular member.

In certain embodiments of the invention guide bars are provided to prevent entry of larger objects, such as pipeline pigs, from leaving the main pipeline and enter into the tubular member. In other embodiments of the invention guide bars are axially adjustable relative to the plug so to facilitate the alignment of the guide bars with the inside diameter of the pipeline. Depending on the embodiment, the plug may be either flow-through or solid.

Advantages of the present invention include simple installation and removal of the plug assembly into and from the tubular member, no mechanical moving parts and audio feedback, by means of an audible “pop”, to indicate that he plug assembly has been removably secured in the tubular member.

### BRIEF DESCRIPTION OF THE DRAWINGS

FIG. 1 is a sectioned perspective view of one embodiment of a flow through plug assembly shown removably placed inside one embodiment of a tubular member apparatus, said tubular member shown positioned between a main pipeline and a flange;

FIGS. 2a-2f are various views of the flow-through plug assembly, or components thereof, of embodiment of the FIG. 1;

FIGS. 3a-3h are various views of a preferred embodiment of a flow-through plug setting tool suitable for use with the flow-through plug assembly of embodiment of the FIG. 1;

FIG. 4a is perspective view of a preferred embodiment of a flow-through plug retrieval tool apparatus suitable for use with the flow-through plug assembly of embodiment of the FIG. 1.

FIG. 4b is a perspective view of a preferred embodiment of a removal tool suitable for use with the retrieval tool of FIG. 4a;

FIGS. 5a-5d are various views of one embodiment of a solid plug assembly suitable for use with the tubular member apparatus of the present invention;

FIGS. 6a-7c are various views of the components of the solid plug assembly of the embodiment of FIGS. 5a-5d; and

FIG. 8 is a sectioned side view of a tubular member of the embodiment of FIG. 1, having an inner profile suitable for use with the various embodiments of the plug assemblies of the present invention.

### DETAILED DESCRIPTION OF THE PREFERRED EMBODIMENTS

Reference is to be had to the Figures in which identical reference numbers identify similar components.

Referring to the Figures, the removable closure system 10 of the present invention comprises a tubular member 12 having a opening 20 for the passage of tools or for flow of liquids or gases therethrough and a plug assembly 14. The tubular member 12 may be a nipple 12a which is attachable to a pipeline 13. The invention herein is not limited in use only to a nipple 12a, but is a system for removably placing a plug assembly 14 inside any tubular member 12 or opening 20; the nipple 12a being example of a tubular member 12 and illustrated herein only because it is a typical environment for the application of the removable plug system 10 of this invention. For example, the tubular member 12 may also be a low-profile flange, a flanged section of pipe or a section of pipeline.

The tubular member 12 has an entrance end 16 and a plug end 18. The plug end 18 is shown of the type that is particularly configured for welding to a pipe 13 or to other conduit. The opening 20 defines an internal surface 22 with a profile 24 therein. The profile 24 provides a collet shoulder 26 and a plug stopping shoulder 28. Preferably the collet shoulder 26 is provided by a circumferential groove 26a in the profile 24 and the plug stopping shoulder 28 is provided by a circumferential ledge 28a on the profile 24. Preferably, the collet shoulder 26 is closer to the entrance end 16, compared to the plug stopping shoulder 28 and the shoulders 24, 26 face towards each other.

The plug assembly 14 comprises a plug 30 and a collet 32. The collet 32 has fingers 32f which radially deflect between a normally expanded state or condition and a contracted state or condition. Preferably, the collet fingers 32f have a finger shoulder 34 which is suitable for engaging the collet shoulder 26 when the collet 32 is in the normally expanded condition. More preferably, when in the contracted condition the outer edge of each collet finger 32f is substantially even with or within the external diameter of the plug 30, and when in the expanded condition the finger shoulders 34 of the collet fingers 32f are beyond the external diameter of the plug 30 and receivable within the circumferential groove 26a.

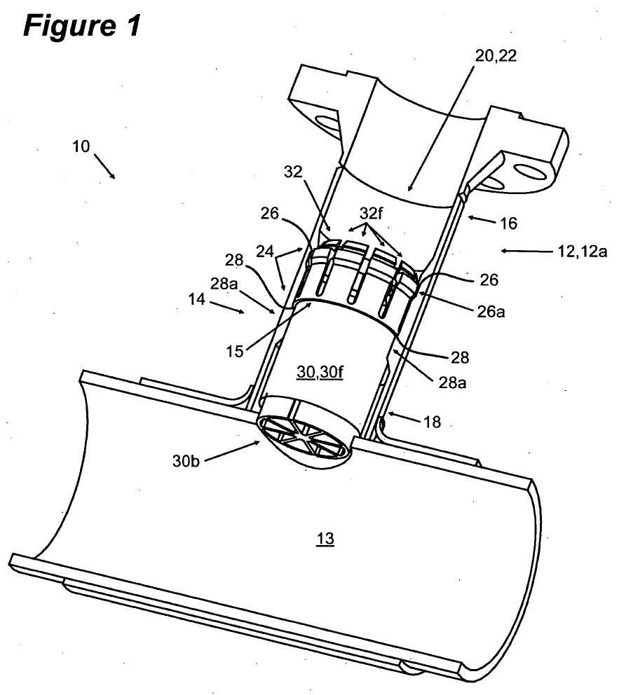

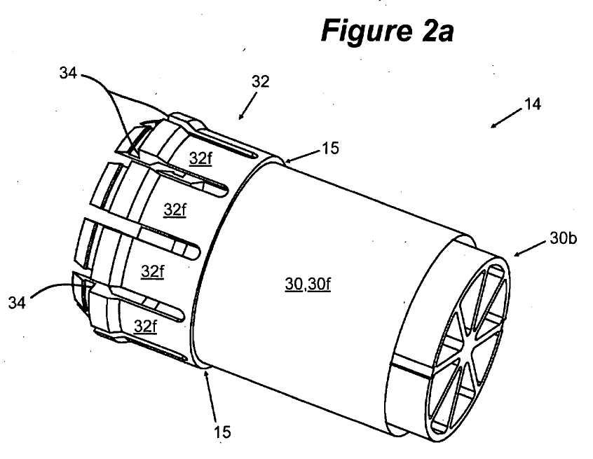

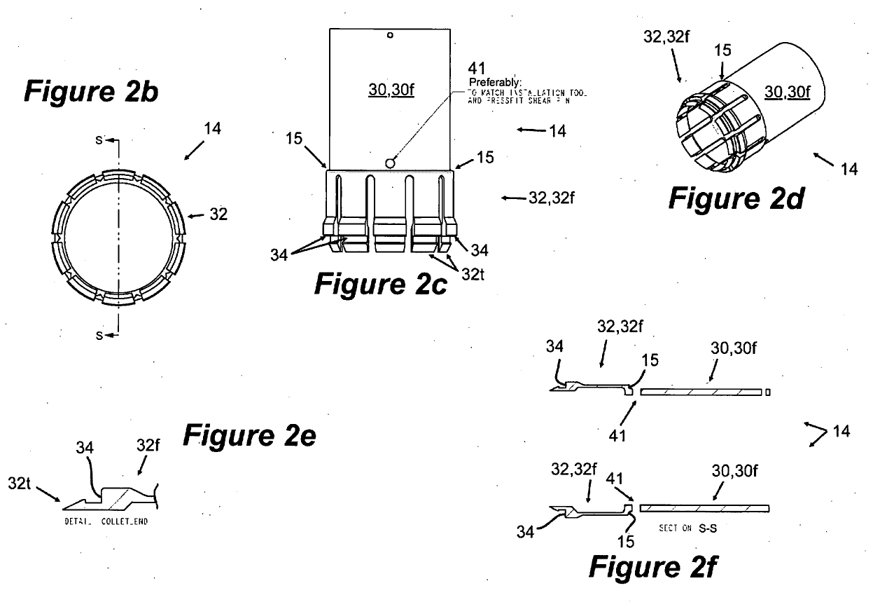

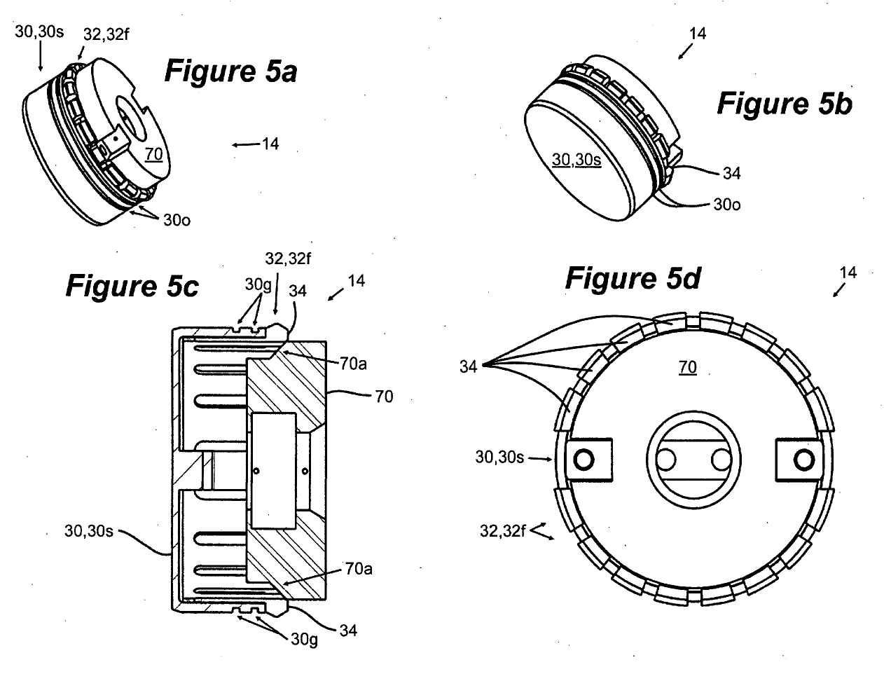

The diameter and shaping of the plug assembly 14, regardless of the state or condition of radial deflection of the collet 32, is such that the assembly 14 cannot fully pass through the tubular member 20 past the plug stopping shoulder 28. For example, in the preferred embodiment, the plug assembly 14 further comprises a plug shoulder 15 at the interface of the plug 30 and the collet 32 (see FIGS. 1 and 2a). Said plug shoulder 15 is of such diameter so as to engage the plug stopping shoulder 28, preventing further axial movement of the assembly past said shoulder 28. In the preferred embodiment, however, the plug 30 is able to extend past the shoulder 28 to a certain degree; preferably as far as to the opening or interface between the pipeline 13 and tubular member, so as to prevent pipeline pigs from getting stuck in the opening to the tubular member 20. However, in the solid plug embodiment, the plug 30 is of such diameter that it rests against the shoulder 28 and no part of the plug 30 extends past said shoulder 28 (see FIGS. 5a-5d.

The plug stopping shoulder 28 thus functions as a stop to retain the plug assembly 14 and prevent further axial movement of the assembly 14 through the tubular member 20.

Furthermore, the diameter of the plug assembly 14, when the collet fingers 32f are in the contracted condition, is such that it is able to pass through the tubular member 20 past the collet shoulder 26.

The plug assembly 14 may be set, that is removably secured, inside the tubular member 20, so as to prevent further axial movement of the assembly 14 through the member 20, as follows:
inserting the plug assembly 14, plug 30 first, into the entrance end 16 of the tubular member 20;
advancing the assembly 14, with the plug 30 first, past the collet shoulder 26 and towards the plug stopping shoulder 28;
contracting the collet 32 and fingers 32f as they passes the collet shoulder 26;
resting the plug 30 against the plug stopping shoulder 28; and
expanding the collet 32 and finger 32f so that the finger shoulders 34 engage the collet shoulder 26 (see FIG. 1).

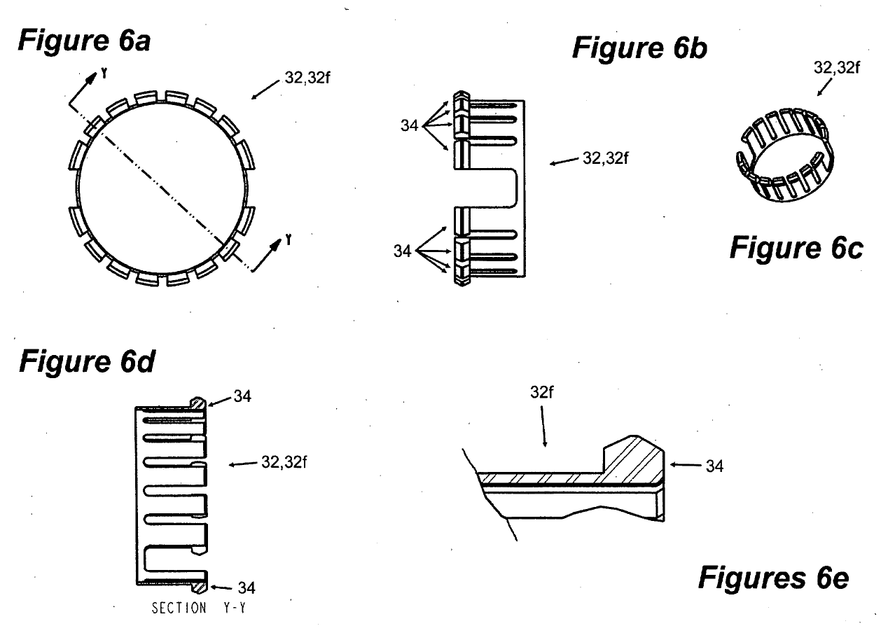

Preferably, the contracting of the collet 32, as it passes the collet shoulder 26, is facilitated by the shape of the profile 24 and the shape of the collet fingers 32f (see FIGS. 2e and 6e), said fingers 32f contacting the profile 24 as the assembly 14 is inserted into the tubular member 20, overcoming the natural tendency of the fingers 32f to stay in the expanded condition thereby forcing the collet 32 to the contracted condition. More preferably, the expanding of the collet 32 is due to the collet 32 returning to its normally expanded condition, once it has passed by the collet shoulder 26. During typical operations, this return of the collet 32 to the normally expanded condition results in an audible “pop”, indicating to the operator that the plug assembly 14 has been removably secured in the tubular member 20. Advantageously, this audible “pop” provides feedback to the operator indicative of a successful installation of the plug assembly 14 inside the tubular member 20

Once the plug assembly 14 is set or removably secured inside the tubular member 20 it may be removed by reversing the above steps: contracting the collet 32 and collet fingers 32f and disengaging the finger shoulders 34 from the collet shoulder 26, retracting the assembly 14 past the collet shoulder 26 and removing the assembly 14 from the tubular member 20.

Setting, Retrieval and Removal Tools

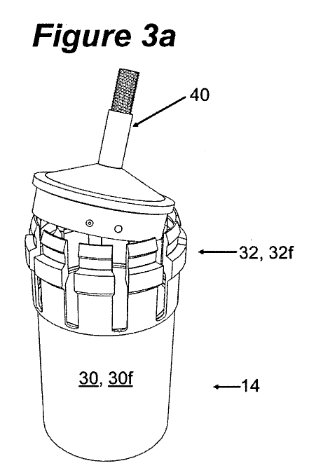

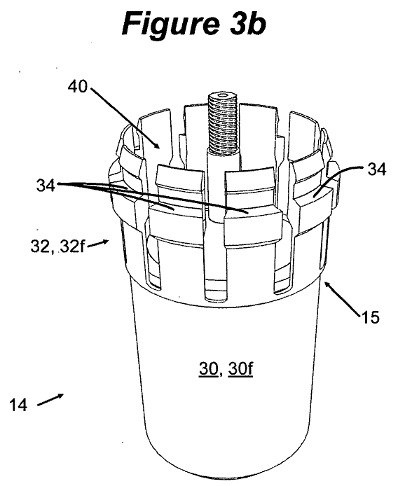

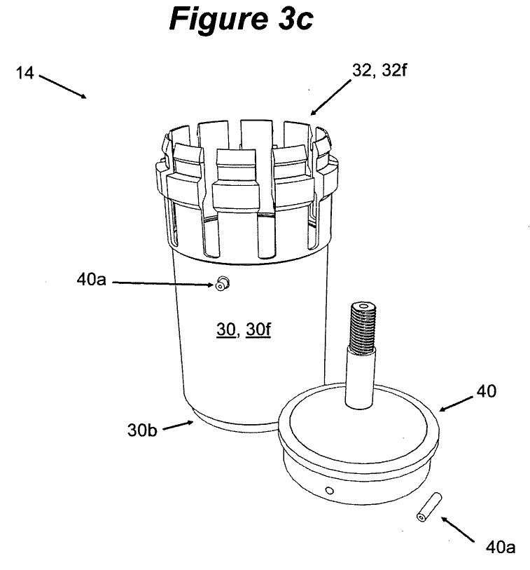

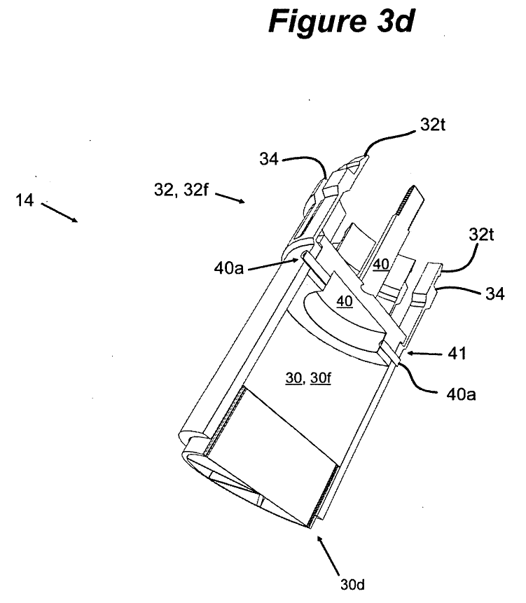

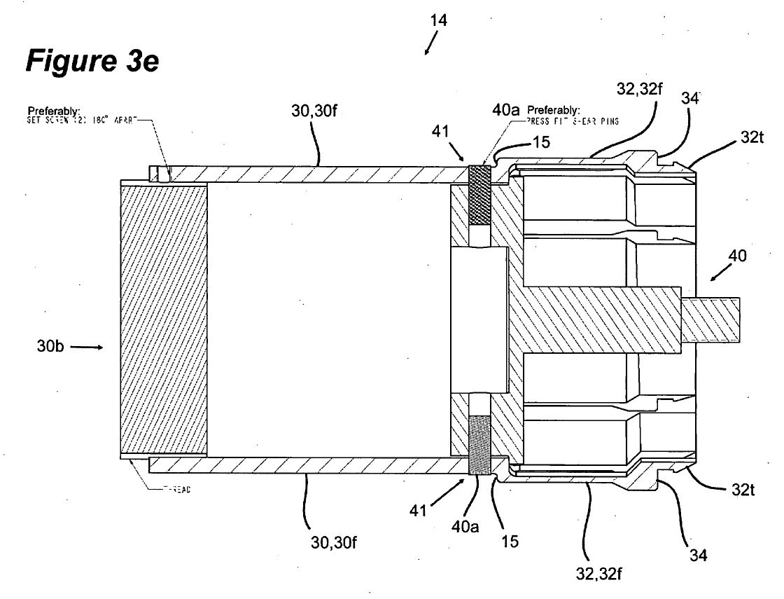

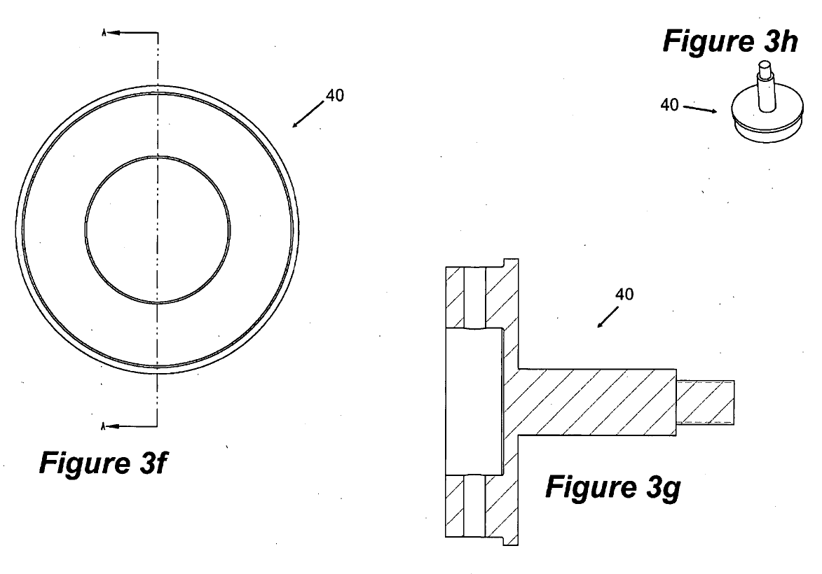

Preferably a setting tool 40 is used to facilitate the insertion and advancement of a plug assembly 14 through the tubular member 20 (see FIGS. 3a-3h). More preferably, the setting tool 40 further comprises one or more shear pins 40a to assist with disconnecting the setting tool 40 from the plug assembly 14 after removably securing the plug assembly 14 in the tubular member 20. Even more preferably, the shear pins 40a are inserted into the tool 40 through holes 41 in the plug 30 (see FIGS. 3c-3e). Setting tools having shear pins are well known to those skilled in the art.

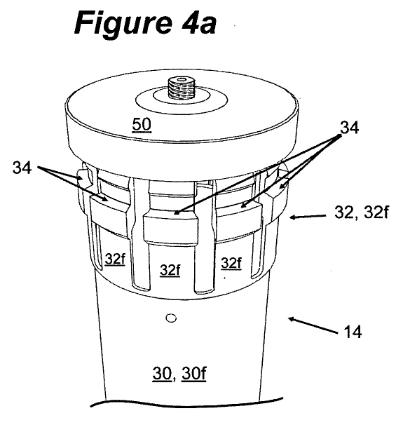

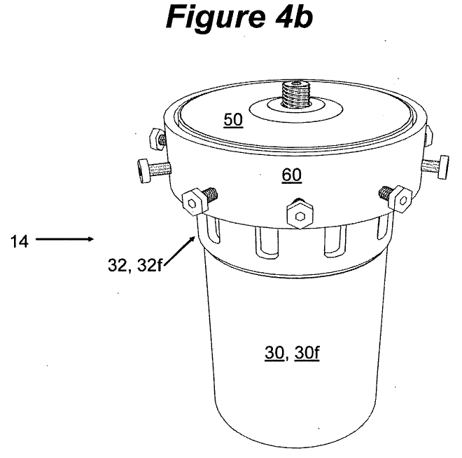

Preferably, a retrieval tool 50 is used to facilitate the contraction the collet 32 and collet fingers 32f and to retrieve or remove the plug assembly 14 from the tubular member 20 (see FIG. 4a). Even more preferably, the retrieval tool 50 and the tips 32t of the collet fingers 32f are shaped so that placement of the retrieval tool 50 on the collet fingers 32f results in a contraction of said fingers 32f and then a slight expansion of the fingers 32f as they become removably secured to the retrieval tool 50 (see FIG. 2e); the overall state of contraction of the fingers 32f still being sufficient to allow the plug assembly 14 to be retrieved or removed from the tubular member 20.

Preferably, a removal tool 60 is used to assist in the removal of the retrieval tool 50 from the tips 32t of the collet fingers 32f, once the plug assembly 14 has been retrieved from the tubular member 20; by causing the collet fingers 32f to contract further (see FIG. 4b).

Various Embodiments of the Plug Assembly

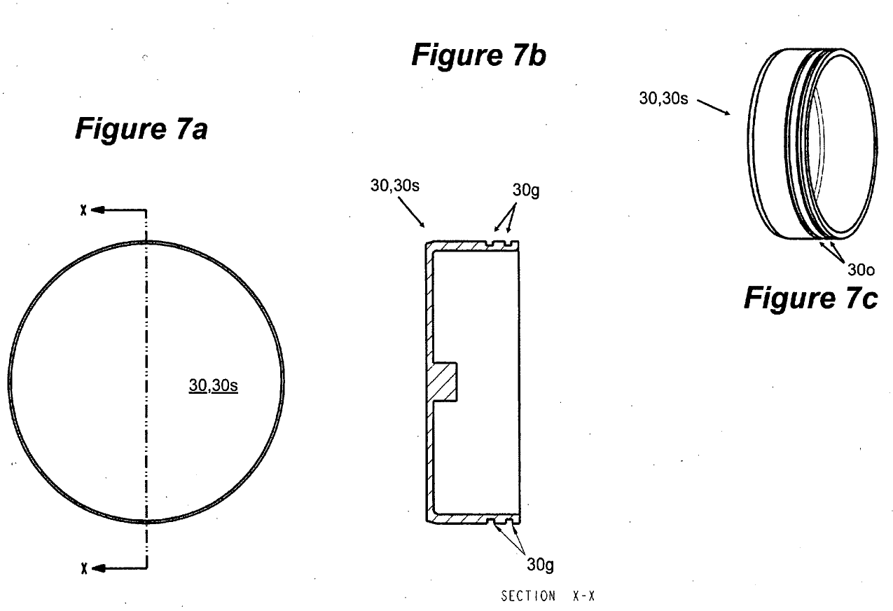

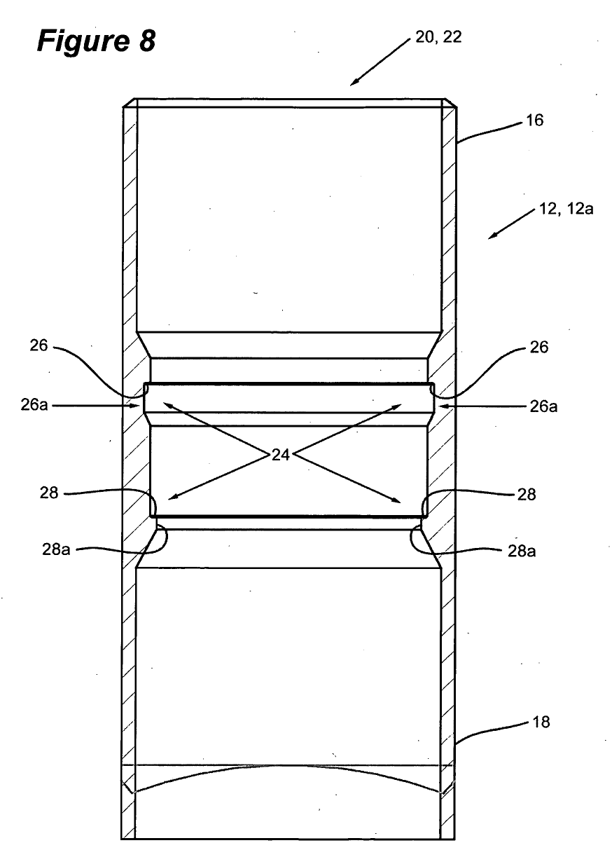

The plug assembly 14 may comprise either a flow-through type of plug 30f (see FIGS. 1-4b), to partially close the tubular member 20, or a solid plug 30s (see FIGS. 5a-7c) to completely close the tubular member 20.

Preferably, in the flow-through plug 30f embodiment, a plurality of guide bars 30b are provided to block the entry of pipeline pigs from the pipeline 13 into the tubular member 20, while still allowing fluid flow to enter the member 20. More preferably, the bars 30b are threadably mounted to the plug 30 so as to enable adjustment of the axial spacing of the bars 30b relative to the plug 30 (see FIG. 3e) prior to inserting the plug 30 into the tubular member 20. Advantageously, such adjustment of the axial spacing of the bars 30b, relative to the plug 30, allows an operator to fine-tune the location of the guide bars 30b and easily adapt the assembly 14 to a variety of thicknesses of pipeline 13 and align the bars 30b with the inside diameter of said pipeline 13. Even more preferably, and once the guide bars 30b are properly spaced and aligned, set screws (not shown) are utilized to lock the guide bars 30b to the plug 30 so as to prevent further axial movement of the bars 30b relative to the plug 30 (see FIG. 3e for a preferable location of a set screw hole in the plug 30).

Preferably, in the solid plug 14b embodiment, one or more circumferential grooves 30g are provided on the external circumferential surface of the plug 30, each groove receiving an O-ring or other form of sealing gasket 30o. Advantageously, the o-ring or sealing gasket 30o further improves the sealing capability of the solid plug 30s embodiment, so as to ensure against leakage of fluids or gases past the plug assembly 14.

More preferably, in the solid plug 14b embodiment, the collet fingers 32f are biased outward, to the expanded condition, by a lock ring 70 (see FIGS. 5a-5d). Preferably the lock ring 70 has an external collet-engaging circumferential ledge 70a, said ledge 70a causing the collet fingers 32f to bias outward when the lock ring 70 is positioned between said fingers 32f and against the plug 30. More preferably the collet-engaging circumferential ledge 70a has a wedge aspect to its surface to fascilitate engagement with the collet fingers 32f (see FIG. 5c).

1. A removable closure system comprising:
a tubular member having an internal surface providing a collet shoulder and a plug stopping shoulder; and
a plug assembly, having a plug suitable for insertion through the tubular member and having collet with a plurality of collet fingers moveable between a collapsed and a normally expanded condition, the collapsed condition suitable for insertion of the plug assembly through the tubular member past the collet shoulder and the expanded condition suitable for engaging the collet shoulder;
wherein, when the plug assembly is placed in the tubular member against the plug stopping shoulder, and the collet fingers are in the expanded condition engaging the collett shoulder, the plug assembly is removably secured in the tubular member.

2. A removable closure system according to claim 1 wherein said tubular member is a nipple.

3. A removable closure system according to claim 1 wherein said tubular member is a flange member.

4. A removable closure system according to claim 1 wherein the collet shoulder is provided by a circumferential groove.

5. A removable closure system according to claim 1 wherein the plug stopping shoulder is provided by a circumferential ledge.

6. A removable closure system according to claim 1 wherein the plug is a flow-through plug.

7. A removable closure system according to claim 1 wherein the plug is a solid plug.

8. A removable closure system according to claim 6 wherein the plug assembly further comprises a plug shoulder and wherein at least a portion of the plug extends past the plug shoulder.

9. A removable closure system according to claim 6 wherein the plug further comprises guide bars.

10. A removable closure system according to claim 9 wherein the guide bars are axially adjustable relative to the plug.

11. A plug assembly for use in a tubular member having an internal surface providing a collet shoulder and a plug stopping shoulder, the plug assembly comprising:
a plug suitable for insertion through the tubular member; and
a collet having a plurality of collet fingers moveable between a collapsed and a normally expanded condition, the collapsed condition suitable for insertion of the plug assembly through the tubular member past the collet shoulder and the expanded condition suitable for engaging the collet shoulder;
wherein, when the plug assembly is placed in the tubular member and against the plug stopping shoulder, and the collet fingers are in the expanded condition engaging the collet shoulder, the plug assembly is removably secured in the tubular member.

12. A plug assembly according to claim 11 wherein said tubular member is a nipple.

13. A plug assembly according to claim 11 wherein said tubular member is a flange member.

14. A plug assembly according to claim 11 wherein the collet shoulder is provided by a circumferential groove.

15. A plug assembly according to claim 11 wherein the plug stopping shoulder is provided by a circumferential ledge.

16. A plug assembly according to claim 11 wherein the plug is a flow-through plug.

17. A plug assembly according to claim 11 wherein the plug is a solid plug.

18. A plug assembly according to claim 16 wherein the plug assembly further comprises a plug shoulder and wherein at least a portion of the plug extends past the plug shoulder.

19. A plug assembly according to claim 16 wherein the plug further comprises guide bars.

20. A plug assembly according to claim 19 wherein the guide bars are axially adjustable relative to the plug.

21. A plug assembly removably positionable in an opening, the opening having a circumferential groove therein, comprising:
a plug having an external surface and being removably receivable within said opening; and
a collet with a plurality of collet fingers, each having a finger shoulder and moveable between a collapsed condition in which said finger shoulders are substantially even with or within said external surface and a normally expanded condition in which said finger shoulders are beyond said external surface and receivable within the circumferential groove of the opening.

22. A plug assembly according to claim 21 wherein the plug is a flow-through plug.

23. A plug assembly according to claim 21 wherein the plug is a solid plug.

24. A plug assembly according to claim 22 wherein the plug further comprises guide bars.

25. A plug assembly according to claim 25 wherein the guide bars are axially adjustable relative to the plug.
